(19) United States
(12) Patent Application Publication
(10) Pub. No.: US 2021/0182855 A1
(43) Pub. Date: Jun. 17, 2021

(54) MANAGING PENDING REFUND TRANSACTION FOR A TRANSACTION SYSTEM

(71) Applicant: PayPal, Inc., San Jose, CA (US)

(72) Inventor: Rahul Nair, Dublin (IE)

(21) Appl. No.: 16/717,333

(22) Filed: Dec. 17, 2019

(51) Int. Cl. G06Q 20/40; G06Q 20/08; G06F 40/40; G06N 20/00

(52) U.S. Cl. CPC G06Q 20/407; G06N 20/00; G06F 40/40; G06Q 20/0855

(57) ABSTRACT

Systems and techniques for managing pending refund transactions for a transaction system are presented. A system presents, via an electronic device, a first refund payment option associated with a first interval of time for providing a pending refund payment. The system also presents, via the electronic device, a second refund payment option associated with a second interval of time for providing the pending refund payment. The second interval of time is less than the first interval of time. Furthermore, the second refund payment option is associated with a fee. The system further applies the fee to the pending refund payment to determine a modified refund payment in response to a selection of the second refund payment option. The system also provides the modified refund payment to the electronic account within the second interval of time in response to a selection of the second refund payment option.

### TECHNICAL FIELD

This disclosure relates generally to transaction systems, and more specifically, to managing transactions for a transaction system.

### BACKGROUND

A transaction system can manage and/or process transactions associated with electronic accounts of users. In certain scenarios, a transaction system can offer a refund for a transaction. However, it generally takes a certain interval of time (e.g., 30 days) for a refund to be applied to an electronic account associated with a transaction. Furthermore, during an interval of time (e.g., 30 days) before a refund is applied to an electronic account associated with a transaction, performance (e.g., communication bandwidth, memory, etc.) of the transaction system can be reduced due to, for example, inquiries from users regarding status of the refund, etc. As such, it would be desirable to improve management of refunds and/or transactions associated with a transaction system.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a block diagram of an example, non-limiting system that includes a refund payment component in accordance with one or more embodiments described herein;

FIG. 2 illustrates an example, non-limiting system for managing pending refund transactions for a transaction system in accordance with one or more embodiments described herein;

FIG. 3 illustrates another example, non-limiting system for managing pending refund transactions for a transaction system in accordance with one or more embodiments described herein;

FIG. 4 illustrates an example, non-limiting system associated with a refund payment platform in accordance with one or more embodiments described herein;

FIG. 5 illustrates yet another example, non-limiting system for managing pending refund transactions for a transaction system in accordance with one or more embodiments described herein;

FIG. 6 illustrates yet another example, non-limiting system for managing pending refund transactions for a transaction system in accordance with one or more embodiments described herein;

FIG. 7 illustrates a user interface associated with managing pending refund transactions for a transaction system in accordance with one or more embodiments described herein;

FIG. 8 illustrates another user interface associated with managing pending refund transactions for a transaction system in accordance with one or more embodiments described herein;

FIG. 9 illustrates yet another user interface associated with managing pending refund transactions for a transaction system in accordance with one or more embodiments described herein;

FIG. 10 illustrates a flow diagram of an example, non-limiting method related to managing pending refund transactions for a transaction system in accordance with one or more embodiments described herein;

FIG. 11 is a schematic block diagram illustrating a suitable operating environment; and

FIG. 12 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without one or more of these specific details in various embodiments, or with other methods, components, materials, etc. not explicitly mentioned herein. In other instances, well-known structures and devices are shown in block diagram form to facilitate describing one or more aspects.

Systems and techniques for managing pending refund transactions for a transaction system are presented. For instance, a novel refund payment platform can be provided to facilitate managing pending refund transactions for a transaction system. In an aspect, the refund payment platform can employ a “funds now” approach to offer an approximately immediate refund to a customer with a pending refund. In certain embodiments, the refund payment platform can charge a fee associated with an approximately immediate refund to a customer. In an embodiment, the refund payment platform can apply a charge to an electronic account associated with a pending refund when funds associated with the pending refund are applied to a credit balance of the electronic account.

In another embodiment, the refund payment platform can manage transmission of a request to another electronic account (e.g., an electronic account of a friend or a family member) to lend funds for a pending refund for no fee. In yet another embodiment, the refund payment platform can publish a pending refund request online to allow an institutional entity (e.g., a credit card company, etc.) to lend funds associated with a pending refund for a fee. In yet another embodiment, the refund payment platform can publish a pending refund request via a crowdsourcing platform to allow one or more entities (e.g., one or more other customers) to lend at least a portion of funds associated with a pending refund for a fee. In another aspect, the refund payment platform can employ novel rules management associated with risk evaluation and/or scoring to facilitate offering an approximately immediate refund to a customer with a pending refund.

In yet another aspect, the refund payment platform can provide a novel system architecture integrated with application programming interfaces and communication channels associated with electronic devices and/or servers to facilitate offering an approximately immediate refund to a customer with a pending refund. In yet another aspect, the refund payment platform can provide one or more novel user interfaces for an electronic device to facilitate offering an approximately immediate refund to a customer with a pending refund. As such, a customer can receive funds associated with a pending refund in a shorter amount of time. Furthermore, performance (e.g., communication bandwidth, memory, etc.) of a transaction system can be improved. Moreover, a computing experience associated with a transaction system can be improved.

According to an embodiment, a system can include a memory and a processor. The processor can be configured to execute computer instructions stored in the memory that when executed cause the system to perform operations comprising presenting, via an electronic device, a first refund payment option associated with a first interval of time for providing a pending refund payment in response to determining that a transaction for an electronic account satisfies a defined criterion associated with the pending refund payment. The operations can further comprise presenting, via the electronic device, a second refund payment option associated with a second interval of time for providing the pending refund payment in response to determining that a transaction for an electronic account satisfies a defined criterion associated with the pending refund payment. The second interval of time can be less than the first interval of time. Furthermore, the second refund payment option can be associated with a fee. The operations can further comprise applying the fee to the pending refund payment to determine a modified refund payment in response to a selection of the second refund payment option via the electronic device. The operations can further comprise providing the modified refund payment to the electronic account within the second interval of time in response to a selection of the second refund payment option via the electronic device.

In another embodiment, a computer-implemented method can provide for presenting, by a system having a processor and a memory, a first refund payment option associated with a first interval of time for providing a pending refund payment associated with a transaction for an electronic account. The computer-implemented method can also provide for presenting, by the system, a second refund payment option associated with a second interval of time for providing the pending refund payment. The second interval of time can be less than the first interval of time. Furthermore, the second refund payment option can be associated with a fee. The computer-implemented method can provide for applying, by the system, the fee to the pending refund payment to determine a modified refund payment. The computer-implemented method can also provide for providing, by the system, the modified refund payment to the electronic account within the second interval of time.

In yet another embodiment, a non-transitory computer readable storage medium can comprise instructions that, in response to execution, cause a system including a processor and a memory to perform operations, comprising: presenting a first refund payment option associated with a first interval of time for providing a pending refund payment associated with a transaction for an electronic account, presenting a second refund payment option associated with a second interval of time for providing the pending refund payment, applying the fee to the pending refund payment to determine a modified refund payment, and providing the modified refund payment to the electronic account within the second interval of time. The second interval of time can be less than the first interval of time. Furthermore, the second refund payment option can be associated with a fee.

According to yet another embodiment, a system can include a memory and a processor. The processor can be configured to execute computer instructions stored in the memory that when executed cause the system to perform operations comprising presenting, via an electronic device, a first refund payment option associated with a first interval of time for providing a pending refund payment in response to determining that a transaction for a first electronic account satisfies a defined criterion associated with a pending refund payment. The operations can further comprise presenting, via the electronic device, a second refund payment option associated with a second interval of time for providing the pending refund payment in response to determining that a transaction for a first electronic account satisfies a defined criterion associated with a pending refund payment. The second interval of time can be less than the first interval of time. Furthermore, the second refund payment option can be associated with a second electronic account. The operations can further comprise obtaining, from the second electronic account, a refund payment amount corresponding to the pending refund payment in response to a selection of the second refund payment option via the electronic device. The operations can further comprise providing the refund payment amount to the first electronic account within the second interval of time in response to a selection of the second refund payment option via the electronic device.

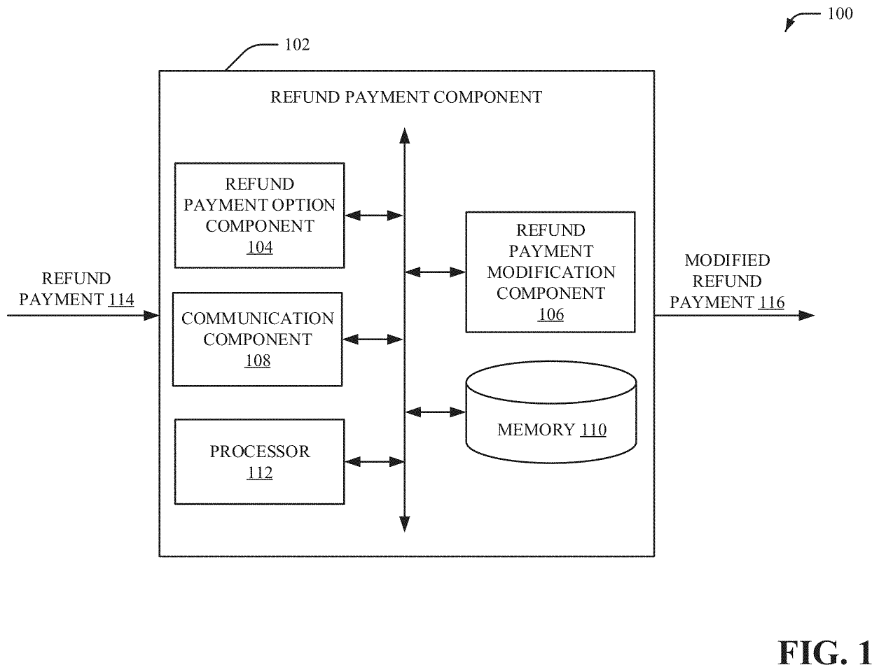

Referring initially to FIG. 1, there is illustrated an example system 100 that manages pending refund transactions for a transaction system, in accordance with one or more embodiments described herein. The system 100 can be implemented on or in connection with a network of servers associated with an enterprise application. In one example, the system 100 can be associated with a cloud-based platform. In an embodiment, the system 100 can be associated with a computing environment that comprises one or more servers and/or one or more software components that operate to perform one or more processes, one or more functions and/or one or more methodologies in accordance with the described embodiments. A sever as disclosed herein can include, for example, stand-alone server and/or an enterprise-class server operating a server operating system (OS) such as a MICROSOFT® OS, a UNIX® OS, a LINUX® OS, and/or another suitable server-based OS. It is to be appreciated that one or more operations performed by a server and/or one or more services provided by a server can be combined, distributed, and/or separated for a given implementation. Furthermore, one or more servers can be operated and/or maintained by a corresponding entity or different entities.

The system 100 can be employed by various systems, such as, but not limited to transaction systems, payment systems, online transaction systems, online payment systems, server systems, electronic device systems, mobile device systems, smartphone systems, virtual machine systems, consumer service systems, mobile application systems, financial systems, digital systems, machine learning systems, artificial intelligence systems, neural network systems, network systems, computer network systems, communication systems, enterprise systems, asset management systems, cloud storage systems, social networking systems, point of sale (POS) systems, and the like (note that the terms used above as examples are not mutually exclusive; a “transaction system” does not imply that system cannot also include or be a payment system, server system, etc.). In one example, the system 100 can be associated with a Platform-as-a-Service (PaaS). Moreover, the system 100 and/or the components of the system 100 can be employed to use hardware and/or software to solve problems that are highly technical in nature (e.g., related to a computing system, related to a server system, related to digital data processing, etc.), that are not abstract and that cannot be performed as a set of mental acts by a human.

The system 100 includes a refund payment component 102. In FIG. 1, the refund payment component 102 can include a refund payment option component 104, a refund payment modification component 106, and/or a communication component 108. Note that in various embodiments, the refund payment option component 104, the refund payment modification component 106, and/or the communication component 108 can be implemented as stored software instructions that are executable by a processor to cause operations to occur. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. The system 100 (e.g., the refund payment component 102) can include memory 110 for storing computer executable components and instructions. The system 100 (e.g., the refund payment component 102) can further include a processor 112 to facilitate operation of the instructions (e.g., computer executable components and instructions) by the system 100 (e.g., the refund payment component 102).

The refund payment component 102 (e.g., the refund payment option component 104 of the refund payment component 102) can receive a refund payment 114. The refund payment 114 can be, for example, a pending refund payment associated with a transaction. For instance, a transaction for an electronic account can be previously executed (e.g., by an online transaction system) and a payment related to the transaction can be previously processed (e.g., by an online transaction system). Furthermore, a refund can be previously applied (e.g., by an online transaction system) for the transaction. An amount of the refund for the transaction can correspond to the refund payment 114. The amount of the refund associated with the refund payment 114 can correspond to at least a portion of the payment related to the transaction. The transaction can be an electronic exchange executed by an electronic device. Furthermore, the transaction can be associated with one or more events (e.g., one or more transaction events) associated with the electronic device. In an aspect, an event associated with the transaction can include a numerical value corresponding to an amount for a transaction. Additionally or alternatively, an event associated with the transaction can include time data related to a timestamp for the transaction. An event associated with the transaction can additionally or alternatively include an item associated with the transaction and/or an identifier for one or more entities associated with the transaction. In certain embodiments, the transaction can include a set of transaction requests for an online transaction system. In certain embodiments, the transaction can be a financial transaction. For example, the transaction can be data to facilitate a transfer of funds for transactions between two entities. In certain embodiments, the transaction can be associated with a web request session. For instance, the web request session can include, for example, establishing a connection with a transaction system (e.g., an online transaction system), sending one or more requests to the transaction system (e.g., an online transaction system) for web session content, and/or receiving web session content from the transaction system (e.g., an online transaction system). In an aspect, the transaction can result in one or more actions, one or more tasks, one or more processes, one or more requests, and/or one or more transmissions being performed via the electronic device and/or an online transaction system in communication with the electronic device.

In an embodiment, the refund payment option component 104 can determine the refund payment 114 in response to determining that the transaction for the electronic account satisfies a defined criterion associated with the pending refund payment. For instance, the refund payment option component 104 can determine the refund payment 114 in response to an option (e.g., an issue a refund option) being selected via a user interface of an electronic device. In one example, the refund payment option component 104 can determine the refund payment 114 in response to the electronic account (e.g., a buyer) or another electronic account (e.g., a seller) associated with the transaction indicating a request for the refund. In certain embodiments, the refund payment option component 104 can determine whether the transaction for the electronic account satisfies the defined criterion associated with the pending refund payment by determining a risk level associated with the transaction for the electronic account. The risk level can be, for example, a risk score that indicates a level of risk associated with the transaction. In another embodiment, the refund payment option component 104 can present a first refund payment option via an electronic device. The first refund payment option can be associated with a first interval of time for providing the pending refund payment associated with the refund payment 114. Additionally, the refund payment option component 104 can present a second refund payment option via the electronic device. The second refund payment option can be associated with a second interval of time for providing the pending refund payment associated with the refund payment 114. The second interval of time associated with the second refund payment option can be less than the first interval of time associated with the first refund payment option. Furthermore, in certain embodiments, the second refund payment option associated with the second refund payment option can be associated with a fee and the first refund payment option associated with the first refund payment option can be associated with no fee. In a non-limiting example, the first refund payment option can be associated with a 30-day interval of time for providing the pending refund payment associated with the refund payment 114. Furthermore, the second refund payment option can be associated with less than a 30-day interval of time for providing the pending refund payment associated with the refund payment 114. For example, the second refund payment option can be associated with an approximately immediate refund payout for providing the pending refund payment associated with the refund payment 114.

The electronic device can be a computing device, a user device, a client device, a mobile device, a smart phone, a tablet device, a handheld device, a portable computing device, a smart device (e.g. an Internet-of-Things devices such as a smart television, etc.), a wearable device, a computer, a desktop computer, a laptop computer, a point of sale (POS) device, and/or another type of electronic device associated with a display (i.e., the electronic device can be more than one of the type of devices listed above, which are non-exclusive categories in various embodiments). In an aspect, the communication component 108 can present the first refund payment option and/or the second refund payment option via a user interface (e.g., a graphical user interface) of the electronic device. For instance, the communication component 108 can render one or more graphical elements associated with the first refund payment option and/or the second refund payment option via a user interface (e.g., a graphical user interface) presented on a display of the electronic device. In certain embodiments, the refund payment option component 104 can aggregate a list of refund payment options associated with respective fees. Furthermore, the communication component 108 can present the list of refund payment options via the electronic device.

The refund payment modification component 106 can determine whether to modify the refund payment 114 based on a selection of the first refund payment option or the second refund payment option via the electronic device. For instance, in response to a selection of the first refund payment option via the electronic device, the refund payment modification component 106 can provide the refund payment 114 within the first interval of time. Alternatively, in response to a selection of the second refund payment option via the electronic device, the refund payment modification component 106 can modify the refund payment 114 to generate a modified refund payment 116. Furthermore, the refund payment modification component 106 can provide the modified refund payment 116 within the second interval of time. In an aspect, the refund payment modification component 106 can apply the fee to the refund payment 114 to generate the modified refund payment 116. The communication component 108 can manage one or more communications and/or one or more transmissions with respect to the electronic device to facilitate determining the selection of the first refund payment option or the second refund payment option via the electronic device. In certain embodiments, the modified refund payment 116 can be associated with a settlement process. For example, the settlement process can rout funds associated with the modified refund payment 116 to one or more payout providers. In certain embodiments, funds associated with the modified refund payment 116 can be provided by multiple sources. For example, funds for the modified refund payment 116 can be aggregated from multiple sources (e.g., one or more institutional payout providers, one or more family members, and/or one or more friends, etc.).

In certain embodiments, the refund payment modification component 106 can perform learning with respect to the refund payment 114 and/or the second refund payment option to facilitate generating the modified refund payment 116. The refund payment modification component 106 can also generate inferences with respect to the refund payment 114 and/or the second refund payment option. The refund payment modification component 106 can, for example, employ principles of artificial intelligence to facilitate learning with respect to the refund payment 114 and/or the second refund payment option. The refund payment modification component 106 can perform learning with respect to the refund payment 114 and/or the second refund payment option explicitly or implicitly. Additionally or alternatively, the refund payment modification component 106 can also employ an automatic classification system and/or an automatic classification process to facilitate learning and/or generating inferences with respect to the refund payment 114 and/or the second refund payment option. For example, the refund payment modification component 106 can employ a probabilistic and/or statistical-based analysis (e.g., factoring into the analysis utilities and costs) to learn and/or generate inferences with respect to the refund payment 114 and/or the second refund payment option. The refund payment modification component 106 can employ, for example, a support vector machine (SVM) classifier to learn and/or generate inferences with respect to the refund payment 114 and/or the second refund payment option. Additionally or alternatively, the refund payment modification component 106 can employ other classification techniques associated with Bayesian networks, decision trees and/or probabilistic classification models. Classifiers employed by the refund payment modification component 106 can be explicitly trained (e.g., via a generic training data) as well as implicitly trained (e.g., via observing user behavior, receiving extrinsic information). For example, with respect to SVM's that are well understood, SVM's are configured via a learning phase or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the refund payment modification component 106 can include an inference component that can further enhance automated aspects of the refund payment modification component 106 utilizing in part inference-based schemes with respect to the refund payment 114 and/or the second refund payment option. The refund payment modification component 106 can employ any suitable machine-learning based techniques, statistical-based techniques and/or probabilistic-based techniques. For example, the refund payment modification component 106 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the refund payment modification component 106 can perform a set of machine learning computations associated with the refund payment 114 and/or the second refund payment option. For example, the refund payment modification component 106 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, and/or a set of different machine learning computations.

Compared to a conventional system, the refund payment component 102 can provide improved performance for an online transaction system. For instance, by employing the refund payment component 102, communication bandwidth associated with an online transaction system can be reduced. Furthermore, with the refund payment component 102, an amount of memory employed by an online transaction system can be reduced. In addition, by employing the refund payment component 102, reliability of execution of a transaction by an online transaction system can be improved and/or a computing experience with respect to an online transaction system can be improved. Moreover, it is to be appreciated that technical features of the refund payment component 102 are highly technical in nature and not abstract ideas. Processing threads of the refund payment component 102 that process the refund payment 114 cannot be performed by a human (e.g., are greater than the capability of a single human mind). For example, the amount of data to manage the refund payment 114, the speed of processing of the refund payment 114 and/or the data types of the refund payment 114 processed by the refund payment component 102 over a certain period of time can be respectively greater, faster and different than the amount, speed and data type that can be processed by a single human mind over the same period of time. Furthermore, in certain embodiments, a portion of the refund payment 114 processed by the refund payment component 102 can be encoded data and/or compressed data. Moreover, the refund payment component 102 can be fully operational towards performing one or more other functions (e.g., fully powered on, fully executed, etc.) while also processing the refund payment 114.

While FIG. 1 depicts separate components in the refund payment component 102, it is to be appreciated that two or more components may be implemented in a common component. Further, it can be appreciated that the design of system 100 and/or the refund payment component 102 can include other component selections, component placements, etc., to facilitate managing a pending refund transaction for a transaction system.

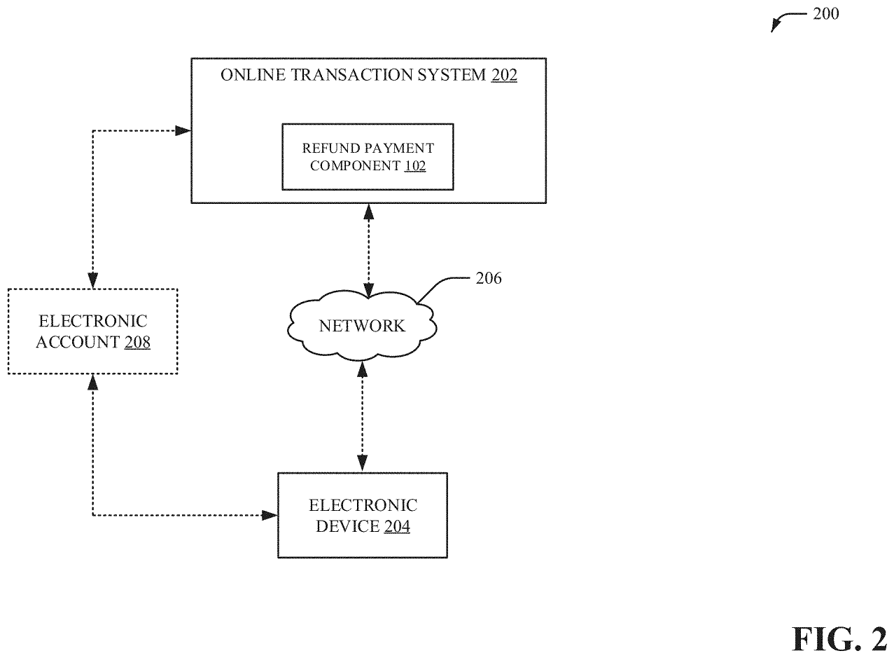

FIG. 2 illustrates an example, non-limiting system 200 in accordance with one or more embodiments described herein. Repetitive description of like elements employed in other embodiments described herein is omitted for sake of brevity. The system 200 includes an online transaction system 202 and an electronic device 204. The online transaction system 202 can be, for example, a server. Furthermore, the online transaction system 202 can include the refund payment component 102. In an aspect, the electronic device 204 can be associated with an electronic account 208. In an embodiment of FIG. 2, the refund payment component 102 can be employed to facilitate managing one or more pending refund transactions associated with the online transaction system 202.

The online transaction system 202 and the electronic device 204 can be in communication via a network 206. The network 206 can be a communication network, a wireless network, an IP network, a voice over IP network, an internet telephony network, a mobile telecommunications network, a landline telephone network, a personal area network, a wired network, and/or another type of network. The online transaction system 202 can be, for example, a stand-alone server and/or an enterprise-class server operating a server OS such as a MICROSOFT® OS, a UNIX® OS, a LINUX® OS, and/or another suitable server-based OS. It is to be appreciated that one or more operations performed by the online transaction system and/or one or more services provided by the online transaction system can be combined, distributed, and/or separated for a given implementation. Furthermore, the online transaction system 202 can be associated with a payment system, an online payment system, an enterprise system, and/or another type of system.

The electronic device 204 can be, for example, an electronic device, a client device, a mobile device, a smart phone, a tablet device, a handheld device, a portable computing device, a smart device (e.g. an Internet-of-Things devices such as a smart television, etc.), a wearable device, a computer, a desktop computer, a laptop computer, a POS device, and/or another type of electronic device associated with a display (i.e., the electronic device 204 can be more than one of the type of devices listed above, which are non-exclusive categories in various embodiments). Furthermore, the electronic device 204 can include one or more computing capabilities and/or one or more communication capabilities. In an aspect, the electronic device 204 can provide one or more electronic device programs, such as system programs and application programs to perform various computing and/or communications operations. One or more of the electronic device programs associated with the electronic device 204 can display a graphical user interface to present information to and/or receive information from one or more users of the electronic device 204. In some embodiments, the electronic device programs associated with the electronic device 204 can include one or more applications configured to execute and/or conduct one or more transaction. In an embodiment, an application program associated with the electronic device 204 can be related to the online transaction system 202.

The electronic account 208 can be managed by the online transaction system 202. Furthermore, the electronic device 204 can access data regarding the electronic account 208 via the online transaction system 202, for example. In certain embodiments, the electronic account 208 can facilitate online payments and/or can provide access to funds. In an embodiment, the electronic account 208 can be associated with one or more transactions. For instance, one or more transactions can be executed and/or initiated via the electronic device 204. The electronic account 208 and/or the electronic device 204 can be associated with a user (e.g., a user identity, a buyer, a seller, etc.). In an example, a transaction for the electronic account 208 can be executed by the online transaction system 202. Additionally or alternatively, a payment related to the transaction for the electronic account 208 can be processed by the online transaction system 202. In another embodiment, data associated with the electronic account 208 can be rendered via a display of the electronic device 204. For instance, data associated with the electronic account 208 can be rendered as one or more visual elements via a display of the electronic device 204. In one example, data associated with the first refund payment option and/or the second refund payment option can be rendered as one or more visual elements via a display of the electronic device 204. In another embodiment, the online transaction system 202 that includes the refund payment component 102 can employ the network 206 and/or the electronic device 204 to determine and/or receive the refund payment 114. In an aspect, performance of the online transaction system 202 can be improved by employing the refund payment component 102. For instance, by employing the refund payment component 102, communication bandwidth associated with the online transaction system 202 can be reduced. Additionally or alternatively, by employing the refund payment component 102, an amount of memory employed by the online transaction system 202 can be reduced. Furthermore, an amount of time for the electronic account 208 to receive a pending refund payment associated with a transaction can be reduced.

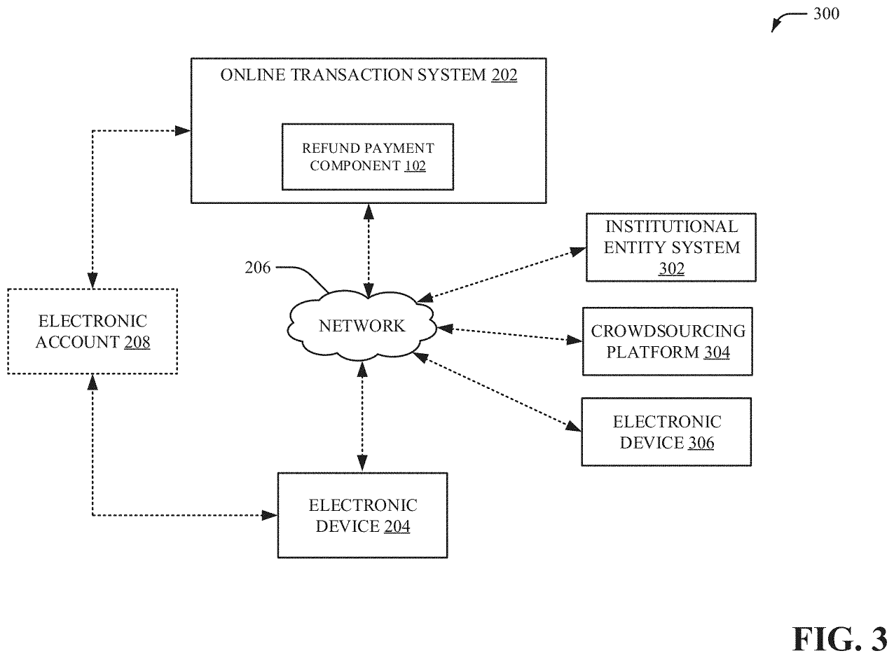

FIG. 3 illustrates an example, non-limiting system 300 in accordance with one or more embodiments described herein. Repetitive description of like elements employed in other embodiments described herein is omitted for sake of brevity. The system 300 includes the online transaction system 202, the electronic device 204, an institutional entity system 302, a crowdsourcing platform 304 and/or an electronic device 306. The online transaction system 202, the electronic device 204, the institutional entity system 302, the crowdsourcing platform 304 and/or the electronic device 306 can be in communication via the network 206. In an aspect, the electronic device 204 can be associated with the electronic account 208. In an embodiment of FIG. 3, the refund payment component 102 can be employed to facilitate managing one or more pending refund transactions associated with the online transaction system 202.

In an embodiment, the institutional entity system 302, the crowdsourcing platform 304 and/or the electronic device 306 can facilitate providing a refund payment for a transaction associated with the electronic device 204 and/or the electronic account 208. For example, the institutional entity system 302, the crowdsourcing platform 304 and/or the electronic device 306 can be third-party payment options that can provide at least a portion of a refund payment for a transaction associated with the electronic device 204 and/or the electronic account 208. The institutional entity system 302 can be, for example, a server system for an institution such as a credit card company, a bank and/or another institution associated with a financial service. The crowdsourcing platform 304 can be, for example, a server system that manages a crowdsourcing service. The electronic device 306 can be associated with another electronic account provided by the online transaction system 202. Furthermore, the electronic device 306 can be associated with another user (e.g., another user identity, a friend, a family member, etc.) that is different than a user for the electronic account 208. In an aspect, the institutional entity system 302, the crowdsourcing platform 304 and/or the electronic device 306 can be employed by the refund payment component 102 to determine at least a portion of the second refund payment option. For instance, the institutional entity system 302, the crowdsourcing platform 304 and/or the electronic device 306 can provide a third-party payment option associated with the second refund payment option. In another embodiment, the online transaction system 202 that includes the refund payment component 102 can employ the network 206, the institutional entity system 302, the crowdsourcing platform 304 and/or the electronic device 306 to determine the modified refund payment 116. For instance, the institutional entity system 302, the crowdsourcing platform 304 and/or the electronic device 306 can determine a fee to apply to the refund payment 114.

The refund payment component 102 of the online transaction system 202 can apply the fee to the refund payment 114 to generate the modified refund payment 116. In an embodiment, the refund payment component 102 of the online transaction system 202 can apply the fee to a credit balance associated with the electronic account 208. In another embodiment, the refund payment component 102 of the online transaction system 202 can apply the fee to a future transaction associated with the electronic account 208. In an aspect, performance of the online transaction system 202 can be improved by employing the refund payment component 102. For instance, by employing the refund payment component 102, communication bandwidth associated with the online transaction system 202 can be reduced. Additionally or alternatively, by employing the refund payment component 102, an amount of memory employed by the online transaction system 202 can be reduced. Furthermore, an amount of time for the electronic account 208 to receive a pending refund payment (e.g., the modified refund payment 116) associated with a transaction can be reduced.

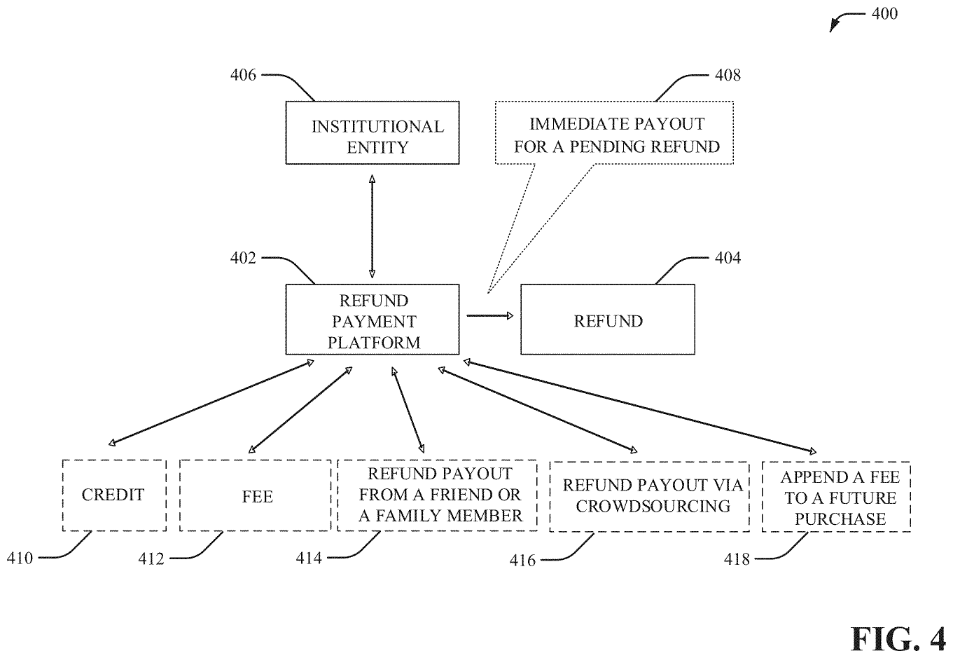

FIG. 4 illustrates an example, non-limiting system 400 in accordance with one or more embodiments described herein. Repetitive description of like elements employed in other embodiments described herein is omitted for sake of brevity. The system 400 includes a refund payment platform 402 that provides a refund 404. For example, the refund payment platform 402 can provide the refund 404 to a payee associated with an electronic account. In an embodiment, the refund payment platform 402 can correspond to and/or can include the refund payment component 102 (e.g., the refund payment component 102 that includes the refund payment option component 104, the refund payment modification component 106, the communication component 108, the memory 110 and/or the processor 112). For example, in an embodiment, the refund 404 can correspond to the modified refund payment 116. In an aspect, the refund 404 can be associated with a pending refund. Furthermore, the refund payment platform 402 can perform a process 408 for immediate payout for a pending refund. The process 408 can result in the refund 404 for the pending refund.

In certain embodiments, the refund payment platform 402 can be in communication with an institutional entity 406 to facilitate providing the refund 404. The institutional entity 406 can correspond to the institutional entity system 302, for example. For instance, the institutional entity 406 can be a server system for an institution such as a credit card company, a bank and/or another institution associated with a financial service. In an aspect, the refund payment platform 402 can determine a refund option for the refund 404. The refund payment platform 402 can determine the refund option from a set of refund options, for example. In an embodiment, the set of refund options can include a refund option 410, a refund option 412, a refund option 414, a refund option 416 and/or a refund option 418. The refund option 410 can apply a credit for the refund 404. For example, with the refund option 410, a credit can be applied to a pending refund (e.g., a credit can be applied to the refund payment 114) to provide the refund 404 (e.g., to provide the modified refund payment 116).

The refund option 412 can apply a fee to provide the refund 404. For example, with the refund option 412, a fee can be applied to a pending refund (e.g., a fee can be applied to the refund payment 114) to provide the refund 404 (e.g., to provide the modified refund payment 116). The refund option 414 can employ a refund payout from a friend or a family member to provide the refund 404. For example, with the refund option 414, a refund payout corresponding to a pending refund (e.g., a refund payout corresponding to the refund payment 114) can be received from a friend or a family member in order to provide the refund 404 (e.g., to provide the modified refund payment 116). The refund option 416 can employ a refund payout via crowdsourcing to provide the refund 404. For example, with the refund option 416, a refund payout corresponding to a pending refund (e.g., a refund payout corresponding to the refund payment 114) can be obtained via crowdsourcing in order to provide the refund 404 (e.g., to provide the modified refund payment 116). In certain embodiments, a fee associated with the crowdsourcing can be applied to the refund payout corresponding to the pending refund.

The refund option 418 can append a fee to a future purchase to provide the refund 404. For example, with the refund option 418, a fee can be applied to a future purchase rather than to a pending refund (e.g., a refund payout corresponding to the refund payment 114). In certain embodiments, the refund payment platform 402 can aggregate a list of refund payment options associated with the refund option 410, the refund option 412, refund option 414, the refund option 416 and/or the refund option 418. The refund payment platform 402 can aggregate a list of respective fees associated with the refund option 410, the refund option 412, refund option 414, the refund option 416 and/or the refund option 418. Furthermore, in an embodiment, the list of refund payment options and/or the respective fees can be presented via an electronic device (e.g., the electronic device 204) in communication with the refund payment platform 402. In certain embodiments, the refund payment platform 402 can consolidate offers associated with the refund option 410, the refund option 412, refund option 414, the refund option 416 and/or the refund option 418. Additionally, the refund payment platform 402 can split fees associated with the refund option 410, the refund option 412, refund option 414, the refund option 416 and/or the refund option 418 to facilitate providing payout amounts to respective entities.

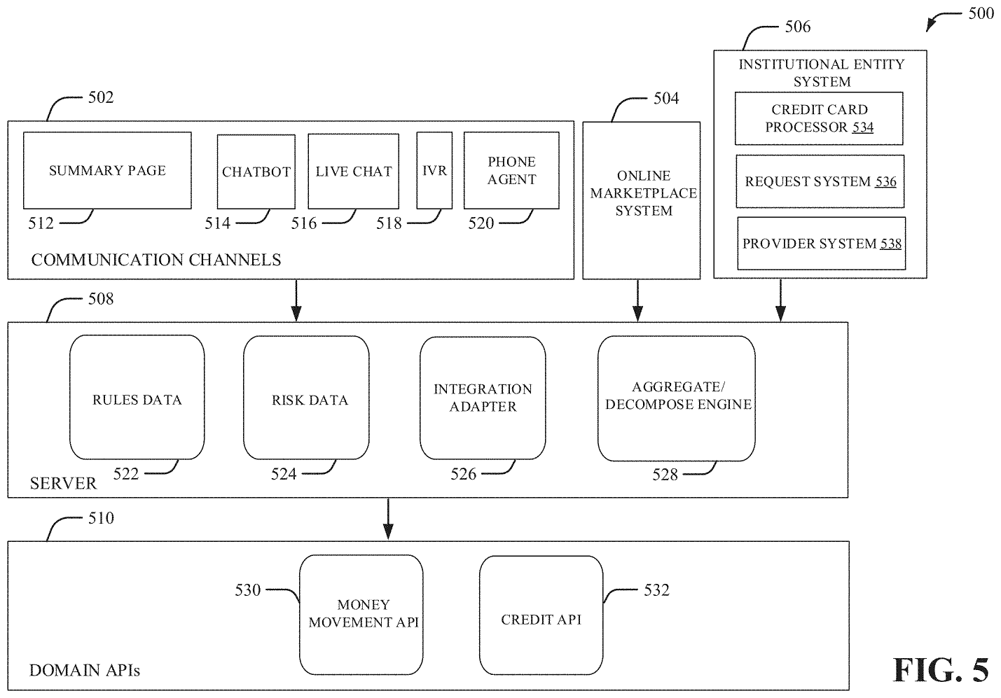

FIG. 5 illustrates an example, non-limiting system 500 in accordance with one or more embodiments described herein. Repetitive description of like elements employed in other embodiments described herein is omitted for sake of brevity. The system 500 includes one or more communication channels 502, an online marketplace system 504, an institutional entity system 506, a server 508 and/or one or more domain application programming interfaces (APIs) 510. In an embodiment, the one or more communication channels 502, the server 508 and/or the one or more domain APIs can be managed by an online transaction system (e.g., the online transaction system 202). The one or more communication channels 502 can include a summary page 512, a chatbot 514, a live chat 516, an interactive voice response (IVR) 518 and/or a phone agent 520. The one or more communication channels 502 (e.g., the summary page 512, the chatbot 514, the live chat 516, the IVR 518 and/or the phone agent 520) can facilitate communication of one or more refund payment options (e.g., the first refund payment option and/or the second refund payment option) to an electronic device (e.g., the electronic device 204). For example, in an embodiment, the communication component 108 can manage the one or more communication channels 502 (e.g., the summary page 512, the chatbot 514, the live chat 516, the IVR 518 and/or the phone agent 520).

The summary page 512 can be, for example, a graphical user interface that displays information associated with one or more transactions and/or one or more refund payment options. In an aspect, the summary page 512 can be rendered on a display of an electronic device (e.g., the electronic device 204). The chatbot 514 can be, for example, an artificial intelligence platform that communicates with an electronic device (e.g., the electronic device 204) via natural language processing and/or speech data. In an aspect, the chatbot 514 can provide information associated with one or more transactions and/or one or more refund payment options via one or more natural language processing techniques. In another aspect, audio data associated with the chatbot 514 can be transmitted via an electronic device (e.g., the electronic device 204). The live chat 516 can be, for example, a messaging system that provides information associated with one or more transactions and/or one or more refund payment options via textual data. In an aspect, textual data associated with the live chat 516 can be rendered on a display of an electronic device (e.g., the electronic device 204). The IVR 518 can be, for example, an automated telephony system that provides information associated with one or more transactions and/or one or more refund payment options. In an aspect, audio data associated with the IVR 518 can be transmitted via an electronic device (e.g., the electronic device 204). The phone agent 520 can be, for example, a user-controlled telephony system that provides information associated with one or more transactions and/or one or more refund payment options. In an aspect, audio data associated with the phone agent 520 can be transmitted via an electronic device (e.g., the electronic device 204). The online marketplace system 504 can be a server system that manages a crowdsourcing service. Additionally or alternatively, the online marketplace can present a set of offers related to a refund payout. The institutional entity system 506 can be, for example, a server system for an institution such as a credit card company, a bank and/or another institution associated with a financial service.

The server 508 can manage and/or employ rules data 522 to facilitate determination of one or more refund payment options (e.g., the second refund payment option). Additionally or alternatively, the server 508 can manage and/or employ risk data 524 to facilitate determination of one or more refund payment options (e.g., the second refund payment option). The server 508 can also include an integration adapter 526 and/or an aggregate/decompose engine 528. The rules data 522 can include one or more rules that facilitate determination of one or more refund payment options (e.g., the second refund payment option). For example, a rule from the rules data 522 can be a criterion for a refund payment option. The risk data 524 can include information regarding risk for a particular refund payment. For example, the risk data 524 can include historical data associated with one or more previous transactions related to an electronic account (e.g., the electronic account 208), a customer risk score for a customer associated with a pending refund payment, a risk score for a particular refund payment option and/or other risk data. The integration adapter 526 can manage integration of information provided by the one or more communication channels 502, the online marketplace system 504 and/or the institutional entity system 506. The aggregate/decompose engine 528 can aggregate and/or decompose refund payment offers from the online marketplace system 504 and/or the institutional entity system 506. In certain embodiments, the aggregate/decompose engine 528 can aggregate and/or decompose multiple transactions to provide an improved refund payment option. In certain embodiments, the aggregate/decompose engine 528 can aggregate funds from multiple sources to provide the modified refund payment 116. For example, the aggregate/decompose engine 528 can aggregate funds for the modified refund payment 116 from one or more institutional payout providers, one or more family members, and/or one or more friends. In one example, the aggregate/decompose engine 528 can aggregate funds from friends/family only who vouch to loan at least a portion of funds for a refund payment associated with a transaction (e.g., more than one friend/family can provide at least a portion of funds for a refund payment associated with a transaction). In another example, the aggregate/decompose engine 528 can aggregate funds from multiple institutional payout providers. In another example, the aggregate/decompose engine 528 can aggregate funds from a mix of friends/family and institutional entities.

The one or more domain APIs 510 can include one or more APIs to facilitate determination of one or more refund payment options (e.g., the second refund payment option). For example, the one or more domain APIs 510 can include a money movement API 530 that can present and/or obtain information regarding movement of money related to a pending refund payment. In an aspect, the money movement API 530 can present and/or obtain information regarding funds and/or fees to facilitate generation of the modified refund payment 116. In another example, the one or more domain APIs can include a credit API 532 that can present and/or obtain information regarding a credit related to a pending refund payment. In an aspect, the credit API 532 can present and/or obtain information regarding a credit to facilitate generation of the modified refund payment 116. In certain embodiments, the institutional entity system 506 can include a credit card processor 534, a request system 536, and/or a provider system 538. The credit card processor 534 can, for example, an entity that provides at least a portion of a refund payment. The request system 536 can be, for example, an entity that requests a refund payment (e.g., the refund payment 114) for a transaction. The provider system 538 can be, for example, an entity that provides (e.g., offers) at least a portion of a refund payment (e.g., the refund payment 114) for a transaction.

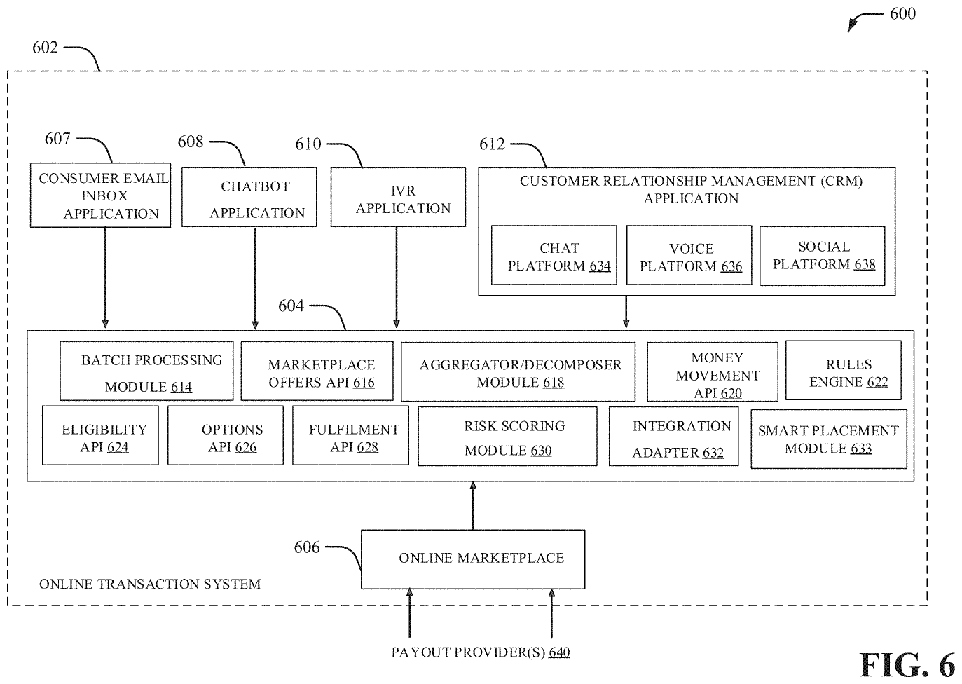

FIG. 6 illustrates an example, non-limiting system 600 in accordance with one or more embodiments described herein. Repetitive description of like elements employed in other embodiments described herein is omitted for sake of brevity. The system 600 includes an online transaction system 602. For example, in an embodiment, the online transaction system 602 can correspond to the online transaction system 202. The online transaction system 602 can include a refund payment platform 604, an online marketplace 606, a consumer email inbox application 607, a chatbot application 608, an IVR application 610 and/or a customer relationship management (CRM) application 612. The refund payment platform 604 can include a batch processing module 614, a marketplace offers API 616, an aggregator/decomposer module 618, a money movement API 620, a rules engine 622, an eligibility API 624, an options API 626, a fulfilment API 628, a risk scoring module 630, an integration adapter 632, and/or a smart placement module 633. The CRM application 612 can include a chat platform 634, a voice platform 636 and/or a social platform 638. In an embodiment, the refund payment platform 604, the online marketplace 606, the consumer email inbox application 607, the chatbot application 608, the IVR application 610 and/or the CRM application 612 can correspond to one or more functionalities associated with the refund payment component 102.

In an embodiment, one or more payout providers 640 can be in communication with the online transaction system 602 via the online marketplace 606. The one or more payout providers 640 can be associated with the institutional entity system 302, the crowdsourcing platform 304 and/or the electronic device 306, for example. The online marketplace 606 can be a server system environment that processes one or more transactions and/or one or more refund payment options. The online marketplace 606 can also facilitate interaction between users and the refund payment platform 604 via one or more user interfaces and/or one or more web sessions. The refund payment platform 604 can facilitate providing a refund payment associated with a transaction. The batch processing module 614 can manage processing of one or more transactions. For example, the batch processing module 614 can process transactions in groups (e.g., batches). In certain embodiments, the batch processing module 614 can identify whether a transaction is associated with a pending refund payment.

The marketplace offers API 616 can return offers from institutional entities interested in offering an immediate payout. This can include managing one or more refund offers (e.g., one or more refund payment options) presented via the online marketplace 606. The aggregator/decomposer module 618 can aggregate and/or decompose refund payment offers from the online marketplace 606. In certain embodiments, the aggregator/decomposer module 618 can aggregate and/or decompose multiple transactions to provide an improved refund payment option for a transaction. The money movement API 620 can present and/or obtain information regarding movement of money related to a pending refund payment. In an aspect, the money movement API 620 move money between at least two parties (e.g., initial immediate refund payout, final settlement when refund remediation begins such as when an entity holds refund money and releases it). This can include presenting and/or obtaining information regarding funds and/or fees to facilitate generation of the modified refund payment 116.

The rules engine 622 can manage one or more rules that facilitate determination of one or more refund payment options. For example, the rules engine 622 can manage a set of criteria for refund payment options presented via the online marketplace 606. The eligibility API 624 can determine when an invoking application wants to decide whether to offer this feature or not (e.g., customer opens third party page that displays the refund pending transaction, a CRM application used by an agent invokes this API so that a call center agent can offer this service to the customer if eligible, and so forth). This can include determining whether a transaction is eligible for modified refund payment and/or a particular refund payment option. The options API 626 can return options available to the beneficiary party. Example options include: 1) apply to credit as a charge 2) receive a loan from a friend/family/other, and/or 3) marketplace offer. The fulfilment API 628 takes in the respective parties that should be paid off as the input, along with specific dollar amounts, and for each, it invokes the money movement API to conclude final settlement. This can include managing fulfilment of a modified refund payment and/or execution of a refund payment option for a transaction.

The risk scoring module 630 can manage historical data associated with one or more previous transactions related to one or more electronic account, customer risk scores for customers associated with a pending refund payment, risk scores for refund payment options, and/or other risk data. The integration adapter 632 can facilitate integration of data from the chatbot application 608, the IVR application 610 and/or the CRM application 612 into the refund payment platform 604. The smart placement module 633 can employ historical data and/or one or more patterns associated with a refund payment (e.g., the refund payment 114) to, for example, adjust an interval of time (e.g., the second interval of time) for providing a pending refund payment. In an aspect, the smart placement module 633 can repeatedly (e.g., continuously) analyze the historical data and/or the one or more patterns to identify an optimal time (e.g., an optimal point in time) to offer a refund payment. In certain embodiments, the rules engine 622 can employ data from the smart placement module 633. For example, the rules engine 622 can employ the optimal time (e.g., an optimal point in time) determined by the smart placement module 633 to determine, for example, a level of risk associated with a refund payment and/or an interval of time for providing a refund payment.

The consumer email inbox application 607 (e.g., gmail, hotmail) that can listen for email notifications that generally transmitted to customers when they return some purchase and are told their money will be returned in X days, X being a positive integer and based on such email notifications for refunds received in the inbox. The email inbox can surface marketing ads for substantially immediate payouts that are offered by the systems and methods described herein.

The chatbot application 608 can be, for example, an artificial intelligence platform that communicates with one or more electronic devices (e.g., one or more electronic devices accessing the online marketplace 606) via natural language processing and/or speech data. In an aspect, the chatbot application 608 can provide information associated with one or more transactions and/or one or more refund payment options via one or more natural language processing techniques. In another aspect, audio data associated with the chatbot application 608 can be transmitted via one or more electronic devices accessing the online marketplace 606. The IVR application 610 can be, for example, an automated telephony system that provides information associated with one or more transactions and/or one or more refund payment options.

In an aspect, audio data associated with the IVR application 610 can be transmitted via one or more electronic devices accessing the online marketplace 606. The CRM application 612 can be, for example, software employed by human user to interact with one or more electronic devices accessing the online marketplace 606. For example, the chat platform 634 can be a messaging system that provides information associated with one or more transactions and/or one or more refund payment options via textual data. In an aspect, textual data associated with chat platform 634 can be rendered on a display of one or more electronic devices accessing the online marketplace 606. The voice platform 636 can be a user-controlled telephony system that provides information associated with one or more transactions and/or one or more refund payment options. In an aspect, audio data associated with the voice platform 636 can be transmitted via one or more electronic devices accessing the online marketplace 606. The social platform 638 can be a social media platform that manages presentation of media content (e.g., image content, audio content, video content, textual content, etc.) associated with one or more transactions and/or one or more refund payment options. In an aspect, media content associated with the social platform 638 can be transmitted via one or more electronic devices accessing the online marketplace 606.

The following description provides implementation aspects to the respective APIs described herein. Each of the respective APIs described herein can include a request specification and a response specification to the request. With respect to the request specification for the eligibility API 624, these can include: Partner platform ID—Unique Identifier attribute to define the platform on which the original transaction and the refunded transaction originated and processed. Party ID—Unique Identifier for the user who originated the transaction and is beneficiary of the refund. Party ID risk score—A numeric score that models the user's platform behavior as low risk/medium risk/high risk in terms. 0 is high risk, 5 is medium risk, 10 is minimal/0 risk. Refund txn ID—A unique identifier for the refunded transaction. Refund txn amount—Dollar amount for the refunded transaction. Refund initiation date—Date when the refund was initiated. Refund txn processor ID—Unique identifier for the entity that is in possession of the funds (e.g., a credit card processor and responsible for releasing funds to the user). Disputed transaction flag (true/false)—True if main transaction was disputed, false if not. Dispute phase—If disputed transaction flag=true, this field captures the phase of the dispute. Value—ongoing, settled in buyer/payer/sender favor, settled in seller/payee/recipient favor.

With respect to the response specification for the eligibility API 624, these can include: Eligibility outcome—PASS/FAIL. Eligibility outcome reason—Text description associated with the eligibility outcome.

With respect to the request specification for the options API 626, these can include: Partner platform ID—Unique Identifier attribute to define the platform on which the original transaction and the refunded transaction originated and processed. Party ID—Unique Identifier for the user who originated the transaction and is beneficiary of the refund. Party ID risk score—A numeric score that models the user's platform behavior as low risk/medium risk/high risk in terms. 0 is high risk, 5 is medium risk, 10 is minimal/0 risk. Refund txn ID—A unique identifier for the refunded transaction. Refund txn amount—Dollar amount for the refunded transaction. Refund initiation date—Date when the refund was initiated. Refund txn processor ID—Unique identifier for the entity that is in possession of the funds (e.g., a credit card processor and responsible for releasing funds to the user). Disputed transaction flag (true/false)—True if main transaction was disputed, false if not. Dispute phase—If disputed transaction flag=true, this field captures the phase of the dispute. Value—ongoing, settled in buyer/payer/sender favor, settled in seller/payee/recipient favor.

With respect to the response specification for the options API 626, these can include: Option ID—unique identifier for an option (e.g., apply to third party credit, receive a loan from a friend). Option terms a flat currency fee or a % fee. Options provider ID—entity that provides the offer (e.g., third party offers third party credit product). Options provider name—name of the entity that provides the offer (e.g., third party provider, name of a friend/family).

With respect to the request specification for the marketplace offers API 616, these can include: Partner platform ID—Unique Identifier attribute to define the platform on which the original transaction and the refunded transaction originated and processed. Party ID—Unique Identifier for the user who originated the transaction and is beneficiary of the refund. Party ID risk score—A numeric score that models the user's platform behavior as low risk/medium risk/high risk in terms. 0 is high risk, 5 is medium risk, 10 is minimal/0 risk. Refund txn ID—A unique identifier for the refunded transaction. Refund txn amount—Dollar amount for the refunded transaction. Refund initiation date—Date when the refund was initiated. Refund txn processor ID—Unique identifier for the entity that is in possession of the funds (e.g., a credit card processor and responsible for releasing funds to the user). Disputed transaction flag (true/false)—True if main transaction was disputed, false if not. Dispute phase—If disputed transaction flag=true, this field captures the phase of the dispute. Value—ongoing, settled in buyer/payer/sender favor, settled in seller/payee/recipient favor.

With respect to the response specification for the marketplace offers API 616, these can include: Offer ID—unique identifier for an offer (e.g., credit card company offers immediate refund for $50 flat fee). Offer terms—a flat currency fee or a % fee. Offer provider ID entity that provides the offer (e.g., credit card company offers immediate refund for $50 flat fee). Offer provider name—name of the entity that provides the offer.

With respect to the request specification for the fulfilment API 628, these can include: Refund txn ID—A unique identifier for the refunded transaction. Refund txn amount—Dollar amount for the refunded transaction. Refund initiation date—Date when the refund was initiated. Refund txn processor ID—Unique identifier for the entity that is in possession of the funds (e.g., a credit card processor and responsible for releasing funds to the user). Refund remediation date—Date when the entity holding the refund funds released them. Payees Array—array of parties who should be paid off to settle the loan that offered immediate payout on the pending refund. Payee ID—unique id for the payee. Amount—dollar amount.

With respect to the response specification for the fulfilment API 628, these can include: Settlement ID—unique id for the final settlement. Payee ID—unique id for the payee. Amount—dollar amount. Status—Success/Fail.

With respect to the request specification for the money movement API 620, these can include: Refund txn ID—A unique identifier for the refunded transaction. Refund txn amount—Dollar amount for the refunded transaction. Refund initiation date—Date when the refund was initiated. Refund txn processor ID—Unique identifier for the entity that is in possession of the funds (e.g., a credit card processor and responsible for releasing funds to the user). Refund remediation date—Date when the entity holding the refund funds released them. Payee ID—unique id for the payee. Amount—dollar amount.

With respect to the response specification for the money movement API 620, these can include: Settlement ID—unique id for the final settlement. Payee ID—unique id for the payee. Amount—dollar amount. Status—Success/Fail.

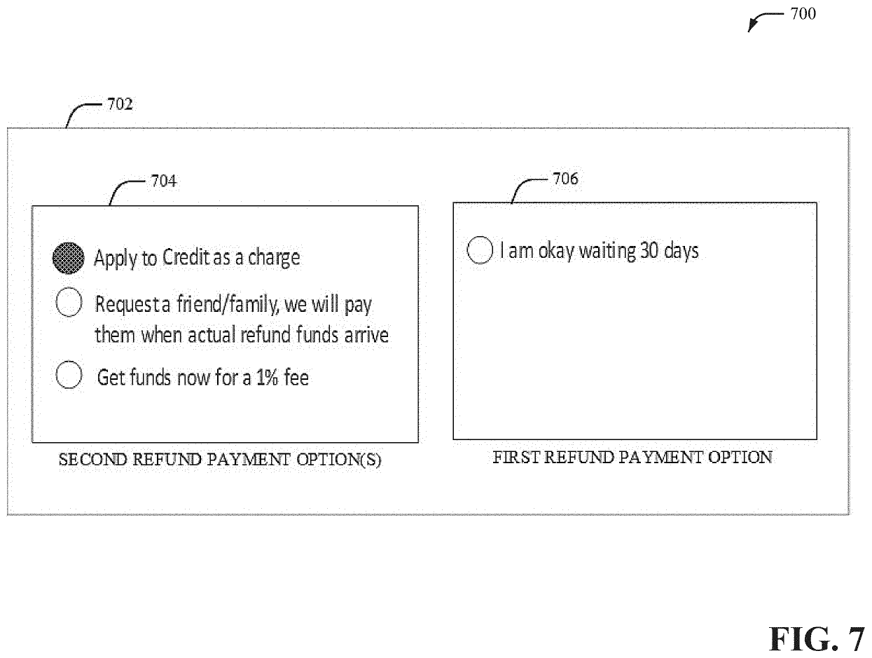

FIG. 7 illustrates an example, non-limiting system 700 in accordance with one or more embodiments described herein. Repetitive description of like elements employed in other embodiments described herein is omitted for sake of brevity. The system 700 includes a user interface 702 to facilitate presenting refund payment options to a user via an electronic device. For example, the user interface 702 can be rendered on a display of the electronic device 204. The user interface 702 can be, for example, a graphical user interface. Furthermore, the user interface 702 can present, for example, one or more second refund payment options 704 and a first refund payment option 706. In an embodiment, the first refund payment option 706 can be associated with a first interval of time for providing a pending refund payment associated with a transaction. For example, the first refund payment option 706 can be a refund payment option where a refund payment is provided in 30 days from a request for the pending refund payment (e.g., “I am ok waiting 30 days”). In another embodiment, the one or more second refund payment options 704 can be associated with a second interval of time for providing the pending refund payment. The second interval of time associated with the one or more second refund payment options 704 can be less than the first interval of time associated with the first refund payment option 706. For example, a refund payment option from the one or more second refund payment options 704 can be associated with an approximately immediate payment of the pending refund payment. In an implementation, a refund payment option from the one or more second refund payment options 704 can be associated with a fee. Additionally or alternatively, a refund payment option from the one or more second refund payment options 704 can offered without a fee. For example, a refund payment option from the one or more second refund payment options 704 can be offered as a credit charge to an electronic account (e.g., “Apply to credit as a charge”). Additionally or alternatively, a refund payment option from the one or more second refund payment options 704 can be offered with no fee when a friend or family member temporarily funds a refund payment (e.g., “Request a friend/family, we will pay them when actual refund funds arrive”). Additionally or alternatively, a refund payment option from the one or more second refund payment options 704 can be offered with a fee (e.g., “Get funds now for a 1% fee”). In an aspect, a user can select a particular refund payment option (e.g., “Apply to credit as a charge”, etc.) via the user interface 702.

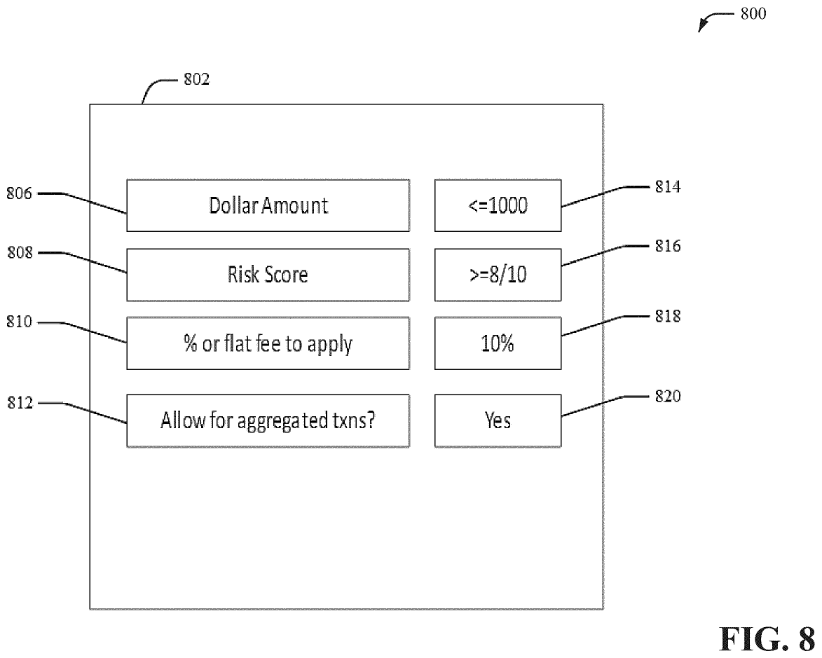

FIG. 8 illustrates an example, non-limiting system 800 in accordance with one or more embodiments described herein. Repetitive description of like elements employed in other embodiments described herein is omitted for sake of brevity. The system 800 includes a user interface 802 to facilitate presenting refund payment options to a user via an electronic device. For example, the user interface 802 can be rendered on a display of the electronic device 204. The user interface 802 can be, for example, a graphical user interface. Furthermore, the user interface 802 can present, for example, information associated with risk management of a refund payment option. In an embodiment, the user interface 802 can include a rule 806 (e.g., dollar amount), a rule 808 (e.g., risk score), a rule 810 (e.g., % or flat fee to apply) and/or a rule 812 (e.g., allow for aggregated transactions?) to facilitate establishing a refund payment option. Additionally, the user interface 802 can include a rule value 814 (e.g., <=1000) associated with the rule 806, a rule value 816 (e.g., <= 8/10) associated with the rule 808, a rule value 818 (e.g., 10%) associated with the rule 810, and/or a rule value 820 (e.g., Yes) associated with the rule 812.

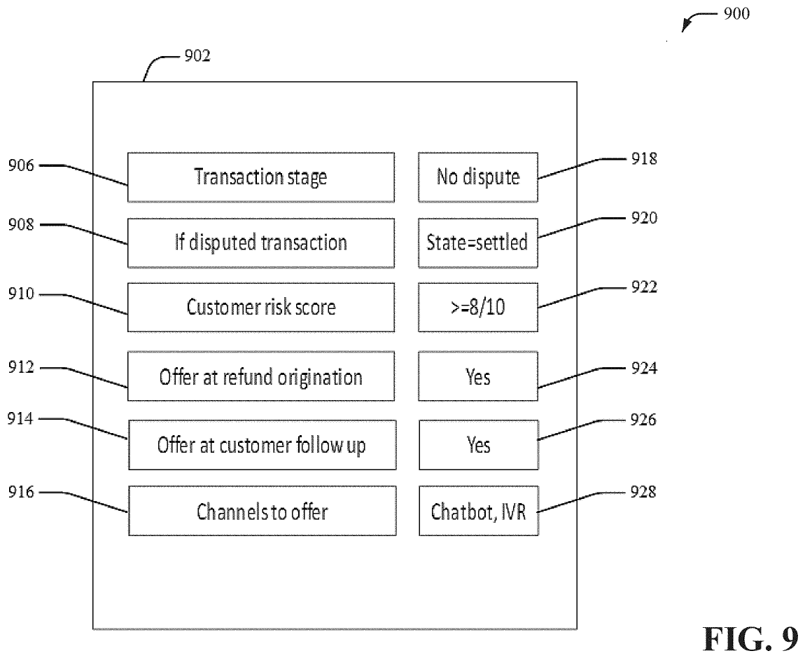

FIG. 9 illustrates an example, non-limiting system 900 in accordance with one or more embodiments described herein. Repetitive description of like elements employed in other embodiments described herein is omitted for sake of brevity. The system 900 includes a user interface 902 to facilitate presenting refund payment options to a user via an electronic device. For example, the user interface 902 can be rendered on a display of the electronic device 204. The user interface 902 can be, for example, a graphical user interface. Furthermore, the user interface 902 can present, for example, information associated with risk management of a refund payment option. In an embodiment, the user interface 902 can include a rule 906 (e.g., transaction stage), a rule 908 (e.g., if disputed transaction), a rule 910 (e.g., customer risk score), a rule 912 (e.g., offer at refund origination), a rule 914 (e.g., offer at customer follow up) and/or a rule 916 (e.g., channels to offer) to facilitate establishing a refund payment option. Additionally, the user interface 902 can include a rule value 918 (e.g., no dispute) associated with the rule 906, a rule value 920 (e.g., state=settled) associated with the rule 908, a rule value 922 (e.g., >= 8/10) associated with the rule 910, a rule value 924 (e.g., Yes) associated with the rule 912, rule value 926 (e.g., Yes) associated with the rule 914, and/or a rule value 928 (e.g., chatbot, IVR) associated with the rule 916.

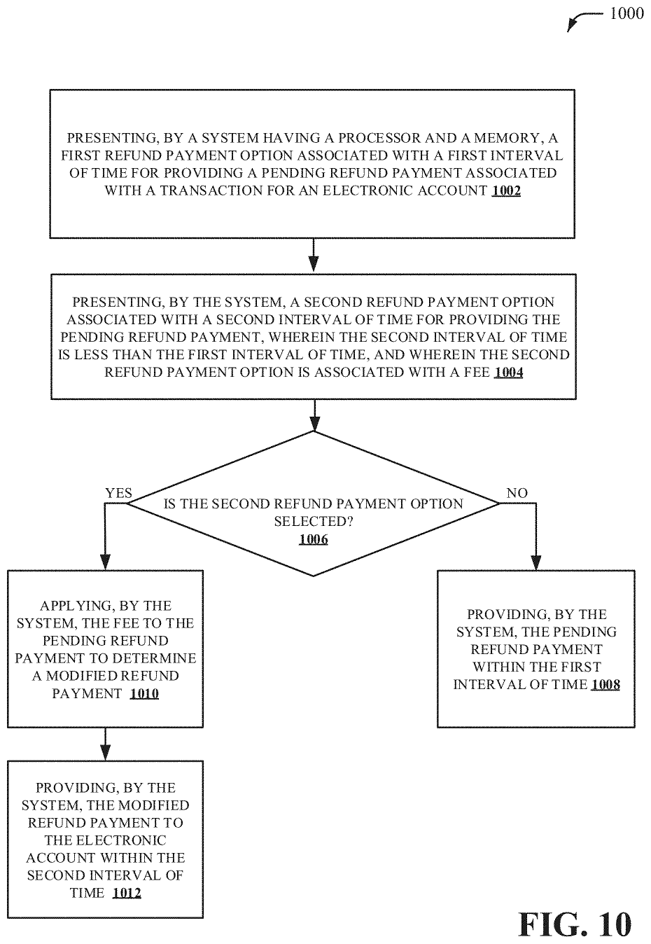

FIG. 10 illustrates a computer-implemented methodology and/or a flow diagram in accordance with the disclosed subject matter. For simplicity of explanation, the methodology is depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodology in accordance with the disclosed subject matter. In addition, those skilled in the art will understand and appreciate that the methodology could alternatively be represented as a series of interrelated states via a state diagram or events. Additionally, it should be further appreciated that the methodology disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 10, there illustrated is a computer-implemented methodology 1000 related to managing a pending refund transaction for a transaction system, according to one or more embodiments. Repetitive description of like elements employed in other embodiments described herein is omitted for sake of brevity. Some or all elements of the computer-implemented methodology 1000 may be performed by the refund payment component 102, according to various embodiments.

At 1002, a first refund payment option associated with a first interval of time for providing a pending refund payment associated with a transaction for an electronic account is presented, by a system having a processor and a memory (e.g., by the refund payment option component 104 and/or the communication component 108). In an aspect, the first refund payment option can be presented via a graphical user interface of an electronic device.

At 1004, a second refund payment option associated with a second interval of time for providing the pending refund payment is presenting by the system (e.g., by the refund payment option component 104 and/or the communication component 108). The second interval of time can be less than the first interval of time. Furthermore, the second refund payment option can be associated with a fee. In an aspect, the second refund payment option can be presented via a graphical user interface of an electronic device. In certain embodiments, a list of refund payment options associated with respective fees can be aggregated. Additionally, the list of refund payment options can be presented via the electronic device. In an embodiment, a third-party payment option associated with an institutional entity that determines the fee can be presented. Additionally or alternatively, a third-party payment option associated with a crowdsourcing platform that determines the fee can be presented. In certain embodiments, the second refund payment option can be presented via an artificial intelligence platform that facilitates communication with an electronic device via natural language processing.

At 1006, it is determined whether the second refund payment option is selected. If no, the computer-implemented methodology 1000 proceeds to 1008. If yes, the computer-implemented methodology 1000 proceeds to 1010.

At 1008, the pending refund payment is provided, by the system (e.g., by the refund payment modification component 106), within the first interval of time. For example, funds associated with the pending refund payment can be added to a balance of the electronic account. After 1008, the computer-implemented methodology 1000 can end.

At 1010, the fee is applied, by the system (e.g., by the refund payment modification component 106), to the pending refund payment to determine a modified refund payment. For example, the modified refund payment can be less than the pending refund payment after applying the fee. In certain embodiments, the fee can be applied to a credit balance associated with the electronic account. In certain embodiments, the fee can be applied to a future transaction associated with the electronic account.

At 1012, the modified refund payment is provided, by the system (e.g., by the refund payment modification component 106), to the electronic account within the second interval of time. For example, funds associated with the modified refund payment can be added to a balance of the electronic account. After 1012, the computer-implemented methodology 1000 can end.

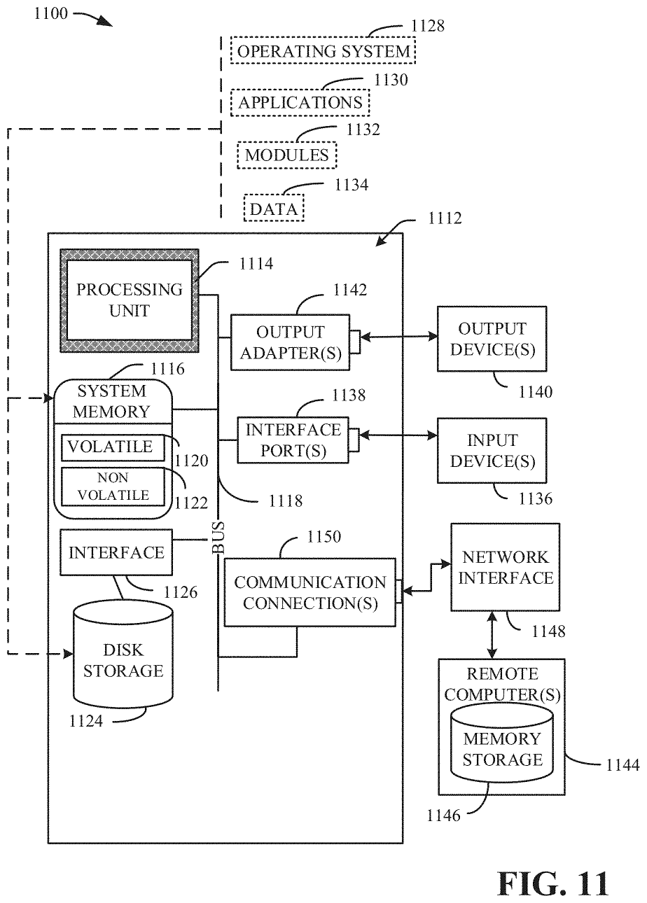

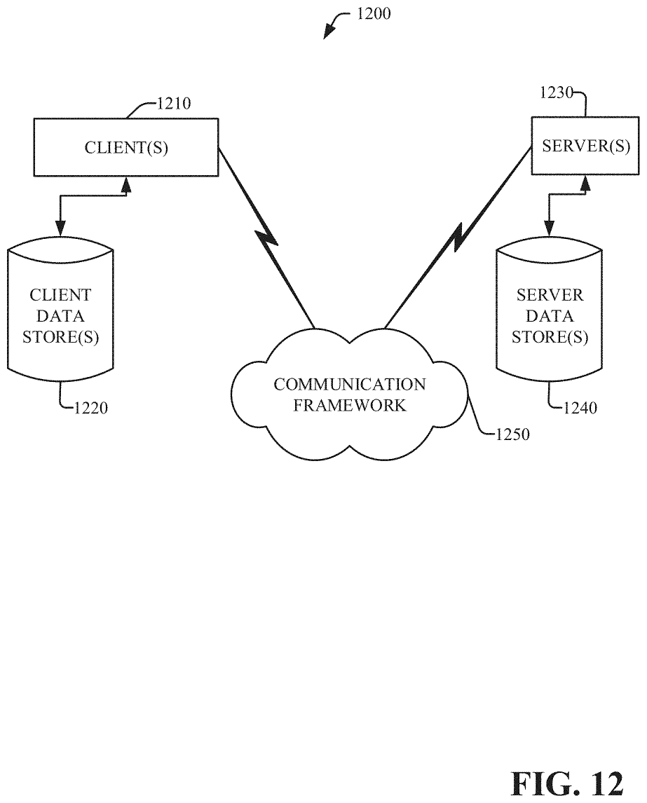

In order to provide a context for the various aspects of the disclosed subject matter, FIGS. 11 and 12 as well as the following discussion are intended to provide a brief, general description of a suitable environment in which the various aspects of the disclosed subject matter may be implemented.

With reference to FIG. 11, a suitable environment 1100 for implementing various aspects of this disclosure includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 also includes removable/non-removable, volatile/nonvolatile computer storage media. FIG. 11 illustrates, for example, a disk storage 1124. Disk storage 1124 includes, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used, such as interface 1126.

FIG. 11 also depicts software that acts as an intermediary between users and the basic computer resources described in the suitable operating environment 1100. Such software includes, for example, an operating system 1128. Operating system 1128, which can be stored on disk storage 1124, acts to control and allocate resources of the computer system 1112. System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 with which the subject matter of this disclosure can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing this disclosure, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1220 that can be employed to store information local to the client(s) 1210. Similarly, the server(s) 1230 are operatively connected to one or more server data store(s) 1240 that can be employed to store information local to the servers 1230.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory; and
a processor configured to execute computer instructions stored in the memory that when executed cause the system to perform operations comprising:
in response to determining that a transaction for an electronic account satisfies a defined criterion associated with a pending refund payment,
presenting, via an electronic device, a first refund payment option associated with a first interval of time for providing the pending refund payment, and
presenting, via the electronic device, a second refund payment option associated with a second interval of time for providing the pending refund payment, wherein the second interval of time is less than the first interval of time, and wherein the second refund payment option is associated with a fee; and
in response to a selection of the second refund payment option via the electronic device,
applying the fee to the pending refund payment to determine a modified refund payment, and
providing the modified refund payment to the electronic account within the second interval of time.

2. The system of claim 1, wherein the presenting the second refund payment option comprises aggregating a list of refund payment options associated with respective fees and presenting the list of refund payment options via the electronic device.

3. The system of claim 1, wherein the presenting the second refund payment option comprises presenting, via the electronic device, a third-party payment option associated with an institutional entity that determines the fee.

4. The system of claim 1, wherein the presenting the second refund payment option comprises presenting, via the electronic device, a third-party payment option associated with a crowdsourcing platform that determines the fee.

5. The system of claim 1, wherein the applying the fee comprises applying the fee to a credit balance associated with the electronic account.

6. The system of claim 1, wherein the applying the fee comprises applying the fee to a future transaction associated with the electronic account.

7. The system of claim 1, wherein the presenting the second refund payment option comprises presenting the second refund payment option via a graphical user interface of the electronic device.

8. The system of claim 1, wherein the presenting the second refund payment option comprises presenting the second refund payment option via an artificial intelligence platform that communicates with the electronic device via natural language processing.

9. The system of claim 1, wherein the determining that the transaction for the electronic account satisfies the defined criterion comprises determining a risk level associated with the transaction for the electronic account.

10. A computer-implemented method, comprising:
presenting, by a system having a processor and a memory, a first refund payment option associated with a first interval of time for providing a pending refund payment associated with a transaction for an electronic account;
presenting, by the system, a second refund payment option associated with a second interval of time for providing the pending refund payment, wherein the second interval of time is less than the first interval of time, and wherein the second refund payment option is associated with a fee;
applying, by the system, the fee to the pending refund payment to determine a modified refund payment; and
providing, by the system, the modified refund payment to the electronic account within the second interval of time.

11. The computer-implemented method of claim 10, wherein the presenting the second refund payment option comprises aggregating a list of refund payment options associated with respective fees and presenting the list of refund payment options via the electronic device.

12. The computer-implemented method of claim 10, wherein the presenting the second refund payment option comprises presenting a third-party payment option associated with an institutional entity that determines the fee.

13. The computer-implemented method of claim 10, wherein the presenting the second refund payment option comprises presenting a third-party payment option associated with a crowdsourcing platform that determines the fee.

14. The computer-implemented method of claim 10, wherein the applying the fee comprises applying the fee to a credit balance associated with the electronic account.

15. The computer-implemented method of claim 10, wherein the applying the fee comprises applying the fee to a future transaction associated with the electronic account.

16. The computer-implemented method of claim 10, wherein the presenting the second refund payment option comprises presenting the second refund payment option via a graphical user interface of an electronic device.

17. The computer-implemented method of claim 10, wherein the presenting the second refund payment option comprises presenting the second refund payment option via an artificial intelligence platform that facilitates communication with an electronic device via natural language processing.

18. A system, comprising:
a memory; and
a processor configured to execute computer instructions stored in the memory that when executed cause the system to perform operations comprising:
in response to determining that a transaction for a first electronic account satisfies a defined criterion associated with a pending refund payment,
presenting, via an electronic device, a first refund payment option associated with a first interval of time for providing the pending refund payment, and
presenting, via the electronic device, a second refund payment option associated with a second interval of time for providing the pending refund payment, wherein the second interval of time is less than the first interval of time, and wherein the second refund payment option is associated with a second electronic account; and
in response to a selection of the second refund payment option via the electronic device,
obtaining, from the second electronic account, a refund payment amount corresponding to the pending refund payment, and
providing the refund payment amount to the first electronic account within the second interval of time.

19. The system of claim 18, wherein the presenting the second refund payment option comprises presenting the second refund payment option via a graphical user interface of the electronic device.

20. The system of claim 18, wherein the presenting the second refund payment option comprises presenting the second refund payment option via an artificial intelligence platform that communicates with the electronic device via natural language processing.
